(19) United States
(12) Patent Application Publication
(10) Pub. No.: US 2009/0141009 A1
(43) Pub. Date: Jun. 4, 2009

(54) LCD Driver IC and Method for Manufacturing the Same

(76) Inventors: Ik Joon CHOI, Seoul (KR); Jong Kee Kim, Suwon-si (KR)

Correspondence Address: THE LAW OFFICES OF ANDREW D. FORTNEY, PH.D., P.C., 401 W FALLBROOK AVE STE 204, FRESNO, CA, 93711-5835, US

(21) Appl. No.: 12/172,183

(22) Filed: Jul. 11, 2008

(30) Foreign Application Priority Data
Dec. 4, 2007 (KR) 10-2007-0124791

(51) Int. Cl. G06F 3/038

(52) U.S. Cl. 345/204

(57) ABSTRACT

Provided are a liquid crystal display (LCD) driver integrated circuit (IC) and a method for manufacturing the same. The LCD driver IC comprises a conductor, a first passivation layer, a first bump, and a first lead. The conductor is disposed on a source driver. The first passivation is disposed on the conductor and comprises a first trench exposing an upper side of the conductor. The first bump fills the first trench. The first lead is disposed on the first bump.

### CROSS-REFERENCE TO RELATED APPLICATIONS

The present application claims priority under 35 U.S.C. 119 and 35 U.S.C. 365 to Korean Patent Application No. 10-2007-0124791 (filed on Dec. 4, 2007), which is hereby incorporated by reference in its entirety.

### BACKGROUND

Embodiments relate to a liquid crystal display (LCD) driver integrated circuit (IC) and a method for manufacturing the same.

In a related thin film transistor LCD (TFT-LCD) device, a gate driver sequentially drives one corresponding gate line under the control of a controller, and a source driver receives data from the controller and applies analog signals to respective source lines of the liquid crystal display (LCD) apparatus to display image data. The related source driver includes from several hundreds to about one thousand driving amplifiers, called channel amplifiers. The amplifiers drive the source terminals of liquid crystal panel TFTs at the same time, and thus, a great amount of heat is generated in the source driver. The heated source driver must be cooled to a temperature that allows continual operation. If the source driver is not cooled to a suitable temperature, it may cause the malfunction of or damage to the LCD device as well as the source driver.

According to the related art, in order to cool the heated source driver to a suitable temperature, the number of the channel amplifiers of the source driver and/or the number of possible colors of the LCD device may be limited.

### SUMMARY

Embodiments provide an LCD driver IC that can efficiently radiate and/or dissipate heat generated in a source driver and a method for manufacturing such an LCD driver IC.

In one embodiment, a liquid crystal display driver integrated circuit comprises a conductor on a source driver; a first passivation layer on the conductor, the first passivation layer comprising a first trench exposing an upper side of the conductor; a first bump filling the first trench; and a first lead on the first bump.

In another embodiment, a method for manufacturing a liquid crystal display driver integrated circuit comprises: forming a conductor on a source driver; forming a first passivation layer on the conductor; forming a first trench selectively in the first passivation layer and exposing the conductor; forming a first bump filling the first trench; and forming a first lead on the first bump.

The details of one or more embodiments are set forth in the accompanying drawings and the description below. Other features will be apparent from the description and drawings, and from the claims.

### BRIEF DESCRIPTION OF THE DRAWINGS

FIG. 1 is a view of an LCD driver IC according to a first embodiment.

FIGS. 2A and 2B are partial cross-sectional views of the LCD driver IC according to the first embodiment.

FIG. 3 is a view of an LCD driver IC according to a second embodiment.

### DETAILED DESCRIPTION OF THE EMBODIMENTS

Hereinafter, an LCD driver IC and a method for manufacturing the same will be described in detail with reference to the accompanying drawings.

In the following description, it will be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under the other layer, and one or more intervening layers may also be present. In addition, it will also be understood that when a layer is referred to as being ‘between’ two layers, it can be the only layer between the two layers, or one or more intervening layers may also be present.

### First Embodiment

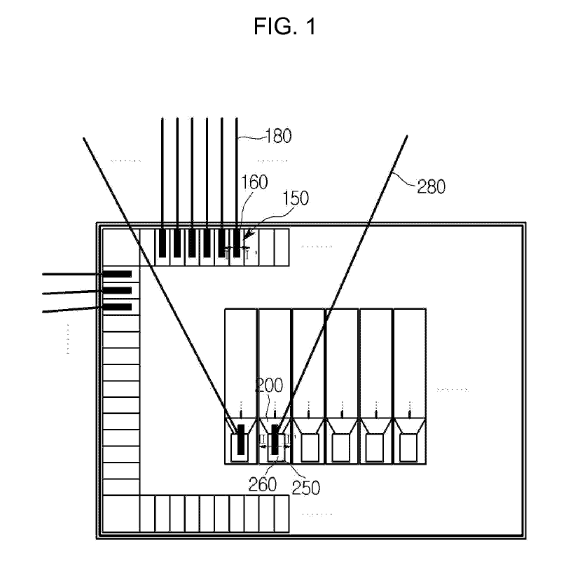

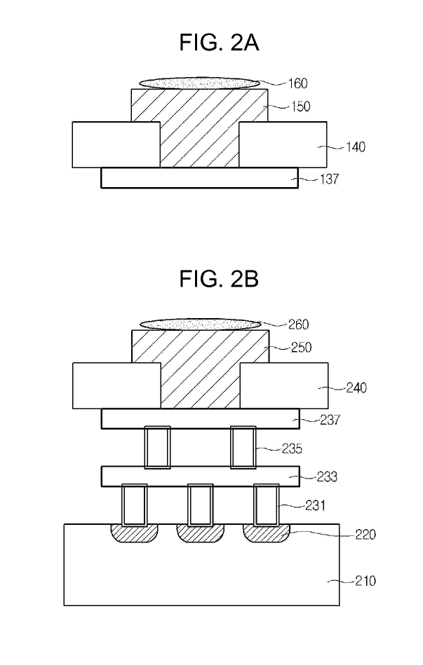

FIG. 1 is a view of an LCD driver IC according to a first embodiment, FIG. 2A is a cross-sectional view taken along line I-I′ of FIG. 1, and FIG. 2B is a cross-sectional view taken along line II-II′ of FIG. 1.

An LCD driver IC according to a first embodiment includes a conductor 137/237 (see FIGS. 2A-2B), a first passivation layer 140/240 (see FIGS. 2A-2B), a first bump 150-250 (see FIGS. 2A-2B), and a first lead 160-260 (see FIG. 2A-2B). The conductor is disposed on a source driver or other LCD driver IC. The first passivation layer 140/240 is disposed the conductor 137/237 and includes a first trench exposing an upper side of the conductor 137/237. The first bump 150/250 fills the first trench. The first lead 160/260 is disposed on the first bump 150/250.

The first bump 150/250 (or other structure, such as conductor 137/237 and/or first lead 160/260) may be disposed on, over or with an amplifier 200 of the LCD (e.g., source) driver. In other words, the bump 150/250 may be in thermal communication with wells 220 of (or in thermal communication with) an amplifier of the LCD driver IC 100 (FIG. 1). Structures may be in thermal communication when there is a path of relatively low thermal resistance between the structures. The conductor (or thermal path, for example, between the LCD driver substrate 210 and conductor 237) may include one or more contact plugs 231/235 and one or more second conductors 233 disposed on or over a well 220 (e.g., of a source driver) corresponding to a transistor constituting the amplifier 250.

Referring to FIG. 1, the first embodiment may further include a first lead line 180/280 connected to the first lead 160/260.

Referring back to FIGS. 2A-2B, the first embodiment may include first and second bumps 150 and 250 disposed outside or over the source driver. First and second leads 160 and 260, and first and second lead lines 180 and 280 connected to the first and second leads 160 and 260, may be disposed on the first and second bumps 150 and 250, respectively. Not explained reference numerals will be described in the following manufacturing process.

In an LCD driver IC and a method for manufacturing the LCD driver IC according to various embodiments, a bump constituting an output portion of a package of an IC and having an excellent thermal conductivity is additionally disposed in, on, over or in thermal communication with a transistor of an amplifier generating a very large amount of heat in a source driver IC. In some embodiments, a portion of the bump may be in direct contact with a portion of a substrate corresponding to a transistor (e.g., of an amplifier) as a via and/or a contact to improve heat transfer out of the LCD (e.g., source) driver IC. Since the heat transfer is improved to suitably maintain an operation temperature of the LCD/source driver IC, an operation of an LCD device or apparatus (such as a computer display, a television display, a cellular telephone display, a personal digital assistant [PDA] display, etc.) having a large size or an extra large size can be stabilized.

Also, since the heat transfer capability is improved sufficiently to allow improved control when varying the voltage or current level(s) that can be outputted from a channel amplifier of the LCD (e.g., source) driver IC, a greater variety of color levels and/or colors with more reliable color characteristics can be displayed.

A method for manufacturing an LCD driver IC according to a first embodiment will now be described with reference to FIGS. 1, 2A, and 2B.

FIG. 2A is a cross-sectional view taken along line I-I′ of FIG. 1. Referring to FIG. 2A, a passivation layer 140 is formed on a top metal layer 137 of a semiconductor device (e.g., an integrated circuit containing DMOS or power transistors) constituting part of a source or other LCD driver IC. The passivation layer 140 may comprise silicon dioxide and/or silicon nitride, although it may comprise other materials conventionally used as passivation layers in power ICs. A trench is formed (generally by photolithographic masking and selective etching of the exposed passivation layer 140) such that the top metal 137 is selectively exposed. A bump 150 filling the second trench is formed.

For example, a material having an excellent electrical conductivity may be used as the second bump 150 (e.g., copper, silver, gold, nickel, palladium, platinum, zinc, aluminum, alloys thereof, etc.). For example, after the second trench is filled with gold, a second lead 160 of a package is compressed with the second bump 150 to form an output terminal for transmitting signals to an external terminal disposed outside an IC.

According to the first embodiment, a very small amount of heat generated from the source driver IC is transmitted through a rear surface of the semiconductor. In addition, a very small amount of heat is transmitted through the second bump 150 and the second lead 160 compressed with the second bump 150. The second bump 150 comprises a material such as copper, silver, or gold having excellent thermal and/or electrical conductivity (e.g., gold has a thermal conductivity of 0.708 cal/cm·sec·deg).

FIG. 2B is a cross-sectional view taken along line II-II′ of FIG. 1.

Referring to FIG. 2B, a conductor is formed on a source driver. The conductor-forming process may include forming one or more contact plugs 231, 235 to a well 220 in a portion of a substrate 210 corresponding to a transistor constituting an amplifier 200.

For example, the contact plug 231 in contact with the well 220 may be formed in a contact hole in a first insulating layer (not shown) on the substrate 210, by a conventional plug-forming process (e.g., formation of the contact hole in a pre-metal dielectric [PMD] layer by photolithographic patterning and etching, deposition of a liner layer [e.g., a Ti/TiN bilayer] along the surfaces of the PMD layer and the exposed surface of the well 220, deposition of a bulk W material by chemical vapor deposition sufficiently to fill the contact hole, then removal of the conductive materials from outside the contact hole by chemical mechanical polishing [CMP] to leave the plug 231 in only the contact hole). A first metal layer 233 may be formed on the contact plug 231. After a second via plug 235 is formed on the first metal layer 233 (by a process substantially similar or identical to that used for forming plug 231), an upper metal layer 237 may be formed to complete the conductor-forming process. In the first embodiment, the number of (stacked) metal layers is not limited to two.

A first passivation layer 240 is then formed on the conductor (e.g., upper metal layer 237). A first trench (not shown) may be formed by selectively etching the first passivation layer 240 to expose the first metal layer 237. Thereafter, a first bump 250 is deposited to fill the first trench, and a first lead 260 is formed on the first bump 250.

A material having an excellent electrical conductivity may be used as the first bump 250. For example, the first trench may be filled with gold, silver, copper, nickel, etc., and the first lead 260 of the package may be compressed or bonded onto the first bump 250. In the first embodiment, the first lead 260 may also transmit or transfer heat.

According to the first embodiment, a structure including the second bump 150 of the source driver IC may be formed on or at an output terminal, and additionally, a structure including the first bump 250 may be formed on the amplifier 200 (of a channel or a source driver IC), which may generate a relatively large amount of heat.

According to the first embodiment, the structure including the first bump 250 is formed on the amplifier 200 using the contact plug 231 and the via plug 235 disposed on a portion of substrate 210 corresponding to the transistor constituting the amplifier 200 to serve as a heatsink plate.

According to the first embodiment, the structure including the first bump 250 is formed on the transistor of the amplifier output terminal, which may transfer a large amount of heat generated by or in the amplifier. The structure including the first bump 250 may be connected to a diffusion region or well of the transistor using the contact and/or via plug (as well as one or more metal layers of the IC) to form a structure such as a heat sink plate. As a result, the generated heat can radiate (or be transferred) outside of the source driver IC through the first bump 250 and the first lead 260 bonded to the first bump 250.

### Second Embodiment

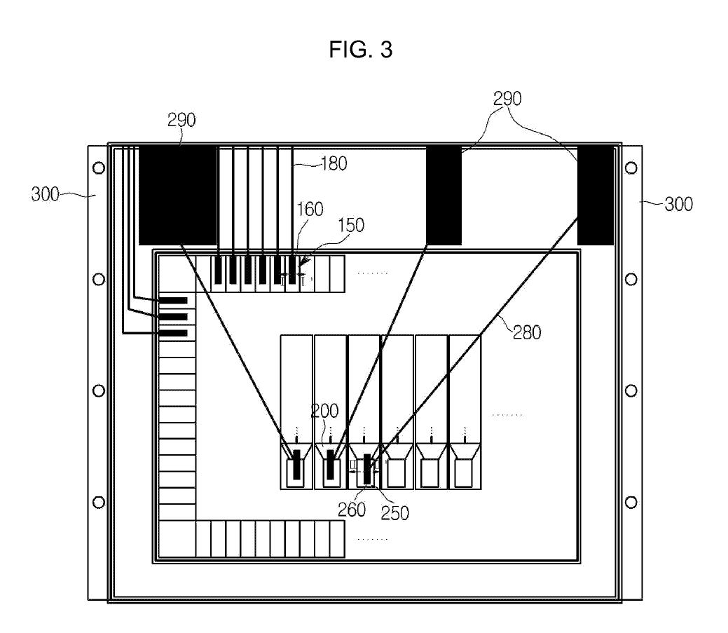

FIG. 3 is a view of an LCD driver IC according to a second embodiment.

An LCD driver IC according to a second embodiment may employ the LCD driver IC according to the first embodiment. For example, an LCD device according to a second embodiment may include a first passivation layer 240 (see FIG. 2B), a first bump 250 (See FIG. 2B), and a first lead 260 (See FIG. 2B). The conductor (exposed in a trench in the first passivation layer 240) may be disposed on a source driver IC, for example. The first passivation layer 240 is on or over the conductor and includes a first trench exposing an upper side or surface of the conductor. The first bump 250 fills the first trench. The first lead 260 is disposed on the first bump 250.

The first bump 250 may be on (or electrically connected to) an amplifier 200 of the source driver. The conductor may include a contact plug 231 to a well 220, corresponding to a transistor in or constituting an amplifier 250. The second embodiment may further include a first lead line 280 connected to the first lead 260. The first embodiment may further include a second bump 150 disposed outside the source driver (e.g., in an area of the IC other than over or in electrical or thermal contact with the driver circuitry). A second lead 160 and a second lead line 180 connected to the second lead 160 may be disposed on or bonded to the second bump 150.

The LCD driver IC according to the second embodiment is connected to the first lead 260 (e.g., electrically and/or thermally), unlike the LCD driver IC according to the first embodiment (which is not necessarily required to be so connected) The second embodiment may further include a conductive plate 290 formed on a film package 300 disposed outside the source driver and a first lead 280 connected to the conductive plate 290. The conductive plate 290 may comprise or be formed of a material having an excellent thermal conductivity such as copper (Cu), silver (Ag), nickel (Ni), aluminum (Al), alloys thereof, etc.

Unlike the method for manufacturing the LCD driver IC according to the first embodiment, a method for manufacturing the LCD driver IC according to the second embodiment may further include forming a first lead line 280 such that the first lead line 280 is connected to a first lead 260 and to a conductive plate 290 of a film package 300 after the first lead 260 is formed. According to the second embodiment, in addition to effects of the first embodiment, the first lead line 280 connected to a first bump 250 may be formed as a heat sink structure, connected to the large conductive plate 290 to improve thermal transfer and/or heat sink performance.

In the LCD driver IC and the method for manufacturing the LCD driver IC according to various embodiments, the bump constituting an output portion of the package of the IC and having excellent thermal conductivity can be additionally disposed on a transistor of an amplifier generating a relatively large amount of heat in the source driver IC, and the portion of the bump and/or other thermally conductive material in (direct) contact with the portion of the substrate corresponding to the transistor of the amplifier (e.g., well 220) can be formed as a via and/or contact to improve the heat transfer out of the source driver IC.

According to various embodiments, since the heat transfer is improved to suitably maintain the operation temperature of the source driver IC, the operation of the LCD device having a large size or an extra large size can be stabilized. Also, since the heat transfer is improved, a plurality of channel amplifiers may be integrated in one (source) driver IC, thereby reducing manufacturing costs. According to certain embodiments, since the heat transfer is improved, the level (e.g., the voltage or current, the range, the absolute value[s], and/or the degree of partitioning) that can be outputted from the channel amplifier of the (source) driver IC, a wide variety of various color levels can be displayed.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A liquid crystal display driver integrated circuit comprising:
a conductor on a source driver;
a first passivation layer on the conductor, the first passivation layer comprising a first trench exposing an upper side of the conductor;
a first bump filling the first trench; and
a first lead on the first bump.

2. The liquid crystal display driver integrated circuit according to claim 1, wherein the first bump is on an amplifier of the source driver.

3. The liquid crystal display driver integrated circuit according to claim 2, wherein the conductor comprises a contact plug in a well corresponding to a transistor constituting the amplifier.

4. The liquid crystal display driver integrated circuit according to claim 1, further comprising:
a conductive plate connected to the first lead, on a film package outside of the source driver; and
a first lead connected to the conductive plate.

5. The liquid crystal display driver integrated circuit according to claim 4, further comprising a second bump outside of the source driver.

6. A method for manufacturing a liquid crystal display driver integrated circuit, the method comprising:
forming a conductor on a source driver of the liquid crystal display driver;
forming a first passivation layer on the conductor;
forming a first trench selectively exposing the first passivation layer to expose the conductor;
forming a first bump filling the first trench; and
forming a first lead on the first bump.

7. The method according to claim 6, wherein the first bump is formed on an amplifier of the source driver.

8. The method according to claim 7, wherein forming the conductor comprises forming a contact plug in a well corresponding to a transistor constituting the amplifier.

9. The method according to claim 6, further comprising forming a first lead line connected to the first lead and a conductive plate on a film package.

10. The method according to claim 9, further comprising forming a second bump outside the source driver.
